(19) United States
(12) Patent Application Publication
(10) Pub. No.: US 2017/0360020 A1
(43) Pub. Date: Dec. 21, 2017

(54) Two-Position Fishing Rod Holder

(71) Applicant: Leonard Kott, Fort McCoy, FL (US)

(72) Inventor: Leonard Kott, Fort McCoy, FL (US)

(21) Appl. No.: 15/183,006

(22) Filed: Jun. 15, 2016

(51) Int. Cl. A01K 97/10

(52) U.S. Cl. CPC A01K 97/10

(57) ABSTRACT

A fishing rod support includes a tubular rod receiver configured to receive and retain the elongated butt-end of a single fishing rod, and a bracket element including two portions with different angular orientations with respect to the tubular receiver. Each of the bracket portions is configured to engage, in like manner, a rigid mount. The mount is configured to be secured to a stable working surface, as a supporting base, such as the rigid structure of a fishing boat. In use, the alternative engaging of the bracket portions with the mount enables two different supported angular orientations of the tubular receiver, and hence of the fishing rod.

### BACKGROUND

The present invention pertains to devices used to support and retain individual fishing rods while in use and for storage. Particularly, the invention pertains to devices for supporting fishing rods from their butt ends on structures typically within the fishing environment, such as fishing boat structures. Prior art rod holders provide for different support angles, but enable this function through geometry adjustment with relative moving parts. Such mechanisms suffer from damage from the associated environment of water that is inherent with fishing activities. What is needed is a rod support that provides for multiple angles of support with a simple device structure free from moving parts and that is adjustable without external tools.

### SUMMARY OF THE INVENTION

The present invention includes a tubular rod receiver configured to receive and retain the elongated butt-end of a conventional single fishing rod. Fixed to the receiver a bracket element including two portions with differing angular orientations with respect to the longitudinal centerline of the tubular receiver. Each of the bracket portions is configured to engage, alternatively, in like manner, a mating mount. The mount is configured to be secured to a stable working surface, as a supporting base, such as the rigid structure of a fishing boat. In use, the alternative engaging of the two bracket portions with the mount enables two different angular orientations of the tubular receiver, and hence a received and supported fishing rod.

In various applications, a mount structure is configured to accept and support the receiver by interconnecting with or retaining the receiver bracket element. The mount may be configured to be attached to external structures such as the exposed walls or deck of boats or to portable stands designed for temporary installation into the ground or beach sand. In alternative configurations, the bracket elements may take the form of alternative, known, mechanically engaging couplings providing the same function and result.

It is an essential element of the inventive design and function that the device be simple and easy to use, and not requirement tools other than a user's hand for operating the device into its alternative configurations. For this reason, the device rod receiver is without intermoving parts but must be a rigid structure.

Additional novel aspects of the inventive devices are made clear through the following detailed description of embodiments of the invention and the associated drawing figures.

### DESCRIPTION OF THE DRAWINGS

FIG. 1 is a perspective view of one embodiment of the inventive rod holder.

FIGS. 2A and 2B are two alternative configurations of the inventive rod holder mounted on a fishing boat.

FIG. 3 is a cross section view of the inventive rod holder together with a mating female bracket element.

### DETAILS OF EMBODIMENTS OF THE INVENTION

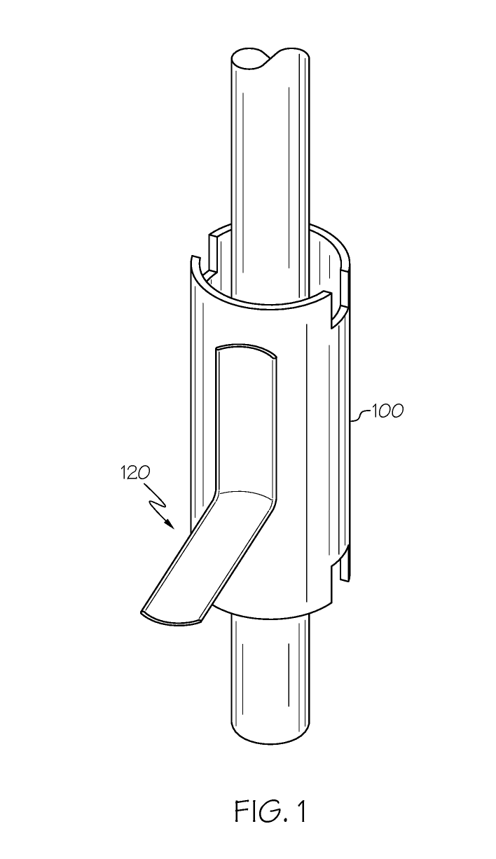

The accompanying illustrations consider the same common embodiment and the following discussion applies to them all. The inventive embodiment illustrated includes an elongated hollow tube receiver 100 having opposing open ends 102, 104. The structure of the receiver 100 performs the essential function of receiving and supporting the elongated butt-end of a common individual fishing rod. In the configuration shown, a fishing rod (FIG. 1) may be received by inserting an elongated butt-end of the rod into one open end 102 of the receiver 100. The rod is prevented from completely passing through the receiver 100 by typical fixtures extending outward from the body of the rod, such as a fishing reel. The rod is supported and retained at least by gravity drawing the rod into the received 100.

For the above purposes, the internal diameter DD of the receiver 100 should preferably be slightly larger than the outer diameter of a typical rod butt end. At the same time, the internal diameter DD should be small enough to provide physical interference with typical reel bodies. Most preferably, the DD should be about 1.25 to 1.5 inches.

Additional rod securing or supporting structures or mechanisms may also be included for convenience or safely. Alternative rigid structures may be used to provide the same rod-supporting function in place of the receiver geometry illustrated in the figures.

An essential feature and function of the invention is the ability to support the receiver 100, and hence a retained rod, in two distinct angular orientations, relative to an associated fixed base or mount. For this purpose, the device has a securing bracket 120 with two distinct portions 142, 144, the two portions 142, 144 mutually oriented with an relative included angle AA.

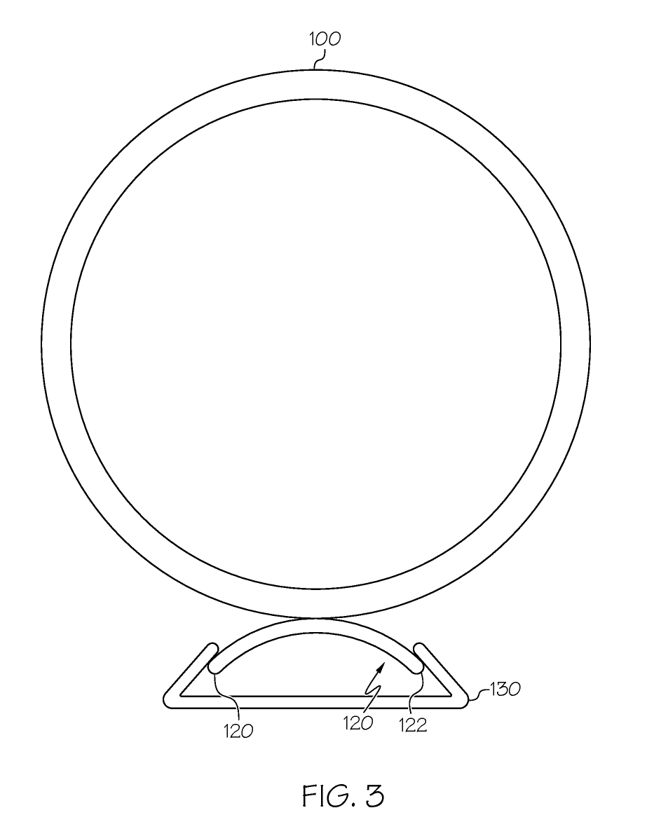

In the configuration shown, the bracket 120 includes two parallel flanges 122, 124 that are configured to be received into the mating slots of a mount 130 (FIG. 3). A fixed position of the receiver 100 may be established by interlocking elements of the flanges 122, 124 and mount 130, or by other separate locking mechanisms providing the same function. In this configuration of the device, it is the edges of the flanges 122, 124 that define the orientation of the respective bracket portions, and hence the mutual included angle AA.

In the configuration illustrated, a first portion 142 of the bracket 120 is aligned with the long axis 200 of the receiver 100 so that when the first portion 142 is mated to a vertically oriented mount 130, the receiver 100 is supported with the long axis 200 vertical in a first condition of use. The second portion 144 is aligned on the receiver 100 with the included angle AA relative to the first portion. Therefore, when this second portion 144 is similarly mated, (alternatively in a second condition of use) with the vertically oriented mount 130, the receiver 100 is supported with an orientation at a relative angle to the vertical; the angle equal to the included angle AA. The particular angle of the included angle AA is not critical, but should be substantially greater than zero; an angle of 45 degrees is useful for many persons.

In the above, the first condition of use is defined with the receiver vertically oriented. It should be clear that the first condition of use may be at any absolute angle that is convenient to the user or for the particular use, with the mount 130 appropriately configured. In all cases, the included angle AA defined a relative angle between the two conditions of use.

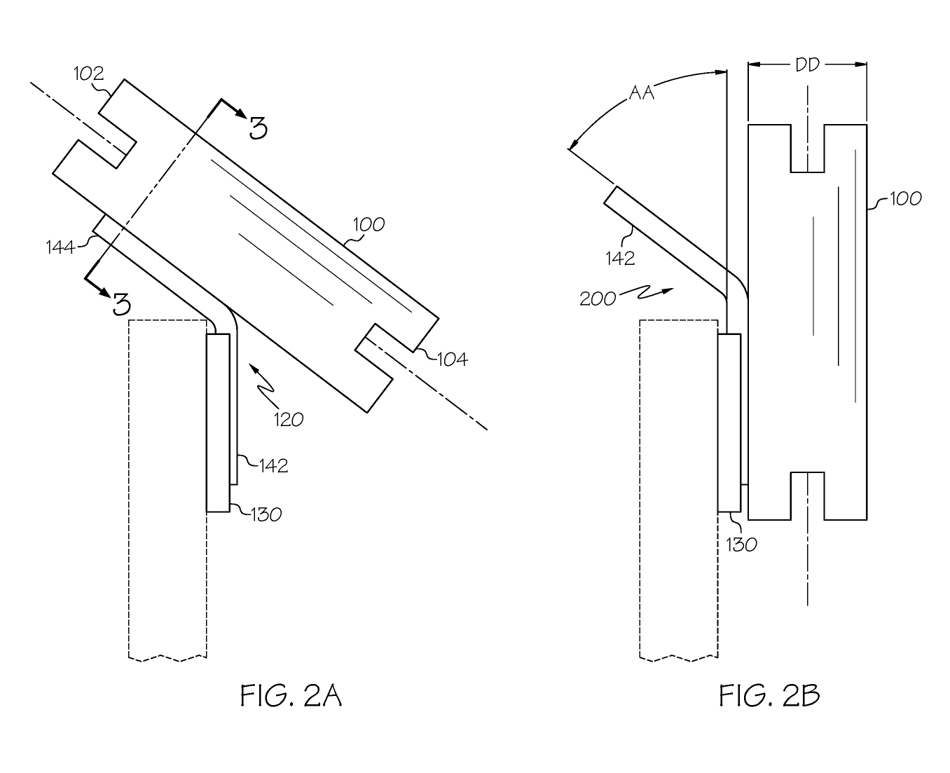

In operation, the receiver 100 may be supported vertically on a mount 130 as seen in FIG. 2A. This orientation has distinct use and value for storage and maintenance of fishing rods when they are not in use. To alter the orientation of the rod, the rod is removed from the receiver 100, the receiver 100 then upended (turned up-side down) and the second bracket portion 144 is secured in the mount 130. The rod is then received anew at the established inclined angle of the receiver 100 (FIG. 2B). It should be noted that this change in orientation is performed and carried out without altering the device structure itself. Unlike prior art devices, the present inventive device includes no parts requiring relative movement to enable the operations described.

The device may be formed from a length of stainless steel tubing to which stainless steel bracket flanges are welded. The specific design and shape of the bracket, flanges and the interlocking elements of the mount 130 is not critical and an acceptable design, and alternatives, will become clear to one skilled in fabrication of similar structures and mechanisms. The device may be formed in alternative modes and alternative materials.

Alternative structures and mechanisms may be employed to carry out the invention for the same functions and purposes. For example, the receiver is preferably configured for supporting fishing rods, but may be configured to receive or support other structures such as flag poles, signs or other articles. The scope of the invention is intended to be defined by the following claims.

I claim:

1. A fishing rod support comprising:
a tubular receiver having an long axis configured to receive an elongated butt portion of a fishing rod;
a rigid bracket integrally secured to the receiver and having a first and second portion;
the first portion parallel to the receiver long axis and the second portion having an included angle from the long axis;
a mount configured to be secured to a rigid structure and configured to receive and retain, alternatively, the first portion or second portion;
whereby the receiver may be retained on the mount with the long axis, alternatively, in one of two different angular orientations.

2. A fishing rod support, according to claims 1, and wherein:
the included angle is 45 degrees.

3. A fishing rod support comprising:
a fishing rod receiver configured to receive a fishing rod;
a mount configured to be secured to a working surface;
the fishing rod receiver configured to engage the mount alternatively in one of two relative angular orientations solely through the actions of:
separating the receiver from the mount;
rigidly rotating the receiver relative to the mount to define a new condition of use; and
engaging the receiver with the mount.

4. A fishing rod support comprising:
a fishing rod receiver configured to receive a fishing rod;
a mount configured to be secured to a working surface;
the fishing rod including a securing means for securing the receiver to the mount, alternatively, in two different angular orientations, and the receiver entirely rigid without intermoving elements.
